(19) United States
(12) Patent Application Publication
(10) Pub. No.: US 2025/0273028 A1
(43) Pub. Date: Aug. 28, 2025

(54) Method for Unlocking at Least One Vehicle Door of a Vehicle, Vehicle and System Comprising at Least One Vehicle and at Least One Mobile Terminal

(71) Applicant: Bayerische Motoren Werke Aktiengesellschaft, Muenchen (DE)

(72) Inventors: Mario ALVAREZ-CASTRILLON, Muenchen (DE); Alaa MOURAD, Muenchen (DE)

(21) Appl. No.: 19/053,597

(22) Filed: Feb. 14, 2025

(30) Foreign Application Priority Data
Feb. 22, 2024 (DE) 10 2024 105 052.7

(51) Int. Cl. G07C 9/00; B60R 25/24

(52) U.S. Cl. CPC G07C 9/00309; B60R 25/245; B60R 2325/101; B60R 2325/103; G07C 2009/00357; G07C 2209/64

(57) ABSTRACT

A method for unlocking at least one vehicle door of a vehicle via a mobile terminal is provided, wherein the vehicle has at least one NFC antenna for receiving NFC signals and a vehicle Bluetooth module for communication via Bluetooth LE, and wherein the mobile terminal has a terminal Bluetooth module for communication via Bluetooth LE and an NFC chip. The at least one NFC antenna is configured to capture data from the NFC chip and then trigger the unlocking. Upon detection of entry of the terminal Bluetooth module into a triggering range of the vehicle Bluetooth module, which is determined at least by the range of a Bluetooth LE signal, this is signaled to the at least one NFC antenna. The at least one NFC antenna then changes from a first mode to a second mode, the first mode being distinguished by a shorter range for capturing the data from the NFC chip than the second mode.

### CROSS REFERENCE TO RELATED APPLICATION

This application claims priority under 35 U.S.C. § 119 from German Patent Application No. 10 2024 105 052.7, filed Feb. 22, 2024, the entire disclosure of which is herein expressly incorporated by reference.

### BACKGROUND AND SUMMARY

The invention relates to a method for unlocking at least one vehicle door of a vehicle via a mobile terminal. Furthermore, the invention relates to a vehicle and a system comprising at least one vehicle and at least one mobile terminal.

A digital key, which can be located on a mobile terminal, is one possible way of unlocking at least one vehicle door of a vehicle. A mobile terminal is in particular a smartphone, a cellphone, a netbook, a notebook, a tablet PC and/or a portable device, which is at least configured to perform NFC (Near Field Communication) and Bluetooth LE (LE—Low Energy). The method of operation of the digital key can be based on UWB technology (Ultra-Wideband technology) which can be used in particular to locate the mobile device. UWB technology has the advantage that it has a long range (depending on the application, the maximum range can be between 10 m and 50 m) and/or has a low energy consumption. The low energy consumption can be due to the low transmission power of, for example, 0.5 mW. A disadvantage of UWB technology is that not every mobile terminal, in particular not every smartphone, is equipped with at least one UWB chip.

Due to the lack of the UWB chip, the mobile terminal is not configured to use UWB technology. In particular, smartphones from some manufacturers do not include a UWB chip.

U.S. Pat. No. 10,343,650B1 discloses an NFC system for unlocking a vehicle via biometric authentication using a smartphone.

The invention is based on the object of providing a method for unlocking at least one vehicle door, which can also be carried out by means of a mobile terminal which does not include a UWB chip.

The object is achieved by the subjects of the independent patent claims. Advantageous developments of the invention are described by the dependent patent claims, the following description and the figures.

The invention is based on the finding that in particular many smartphones do not have a UWB chip and thus cannot be used as a mobile terminal of the digital key as described above. On the other hand, most mobile terminals have at least one NFC chip and a Bluetooth module, which is referred to here as the terminal Bluetooth module for better differentiation. Therefore, the digital key described in the invention is based solely on the two technologies, NFC and Bluetooth, taking into account the energy consumption of the two technologies.

As mentioned, the invention relates to a method for unlocking at least one vehicle door of a vehicle via a mobile terminal, with the method also being referred to as a digital key. The vehicle comprises at least one NFC antenna for receiving NFC signals and a vehicle Bluetooth module for communication via Bluetooth LE. The mobile terminal comprises a terminal Bluetooth module for communication via Bluetooth LE and an NFC chip. An NFC antenna should be understood here as meaning, in particular, the actual antenna for generating and/or receiving the NFC alternating field together with the associated electrical and/or electronic circuit, i.e. overall an NFC antenna circuit.

A single NFC antenna is intended to be considered below. This is not intended to rule out the case that further NFC antennas are installed in the vehicle. Furthermore, this is also not intended to rule out the case that a plurality of NFC antennas are considered instead of one. Preferably, in the case of a plurality of NFC antennas installed in the vehicle, that NFC antenna which is at the shortest distance from the NFC chip and/or via which data from the NFC chip can be or are captured is considered in the following considerations.

NFC is the abbreviation known from the prior art for Near Field Communication and is an international standard for contactless data exchange. The invention provides for this data exchange between the NFC chip and the NFC antenna to preferably be able to be carried out in accordance with standards by virtue of the NFC antenna being configured to capture data from the NFC chip. In other words, the NFC chip provides data, preferably data which are unique, that is to say are provided by only a single NFC chip and thus uniquely identify the NFC chip compared to any other NFC chip. The data can be read by the NFC antenna using NFC technology, with the result that the NFC antenna becomes aware of the data provided by the NFC chip. The NFC chip can be uniquely identified and thus the NFC chip can be distinguished from any other NFC chip.

The invention provides for the unlocking of the at least one vehicle door to be triggered when the data from the NFC chip are captured by the NFC antenna. Preferably, a check is carried out before the unlocking in order to determine whether the NFC chip has already been stored in a memory of the vehicle. An NFC chip can be stored in the memory of the vehicle by means of an initialization, in the course of which the vehicle preferably enquires whether there is an authorization to store, for example by virtue of at least two vehicle keys having to be located in the vehicle at the time of storage and/or an answer to a security question, for example a PIN, having to be entered correctly. The memory is preferably located in the vehicle.

Bluetooth LE is the abbreviation known from the prior art for Bluetooth Low Energy and is a radio technology in which devices can be networked, for example in a surrounding area of 10 m. Bluetooth LE offers the advantage of a significantly lower power consumption compared to Bluetooth. The invention provides for the terminal Bluetooth module and the vehicle Bluetooth module to be configured to set up a communication connection (radio connection) for communication via Bluetooth LE and, in particular, to maintain it for a predefinable time.

The invention comprises that, upon detection of entry of the terminal Bluetooth module into a triggering range of the vehicle Bluetooth module, which is determined at least by a capture range limited by the range of a Bluetooth LE signal, this is signaled to the at least one NFC antenna, and the at least one NFC antenna then changes from a first mode to a second mode, the first mode being distinguished by a shorter range for capturing the data from the NFC chip than the second mode, and the change from the first mode to the second mode results provides a shorter reaction time for the unlocking of the at least one vehicle door.

In other words, the vehicle Bluetooth module has a capture range within which communication with Bluetooth LE is possible. This capture range, in particular its size, may depend on the surrounding area, in particular on objects that are in the surrounding area and are impenetrable to the Bluetooth LE signal. If the vehicle Bluetooth module can set up a connection to the terminal Bluetooth module, the terminal Bluetooth module has entered the capture range of the vehicle Bluetooth module. This entry is communicated to the at least one NFC antenna. The triggering range can be equal to the capture range. In this case, the NFC antenna changes from the first mode to the second mode when the terminal Bluetooth module enters the capture range of the vehicle Bluetooth module. In general, the NFC antenna changes from the first mode to the second mode when the terminal Bluetooth module enters the triggering range. The triggering range either corresponds to the capture range or is a subrange of the capture range. In particular, the NFC antenna is in the first mode by default.

The first mode differs from the second mode in particular by at least one, in particular both, of the following points:
In the first mode, the NFC antenna has a shorter range. This means that, in order to capture the data by means of the NFC antenna, the length of the direct distance (spacing) between the NFC antenna and the NFC chip in the first mode must be less, in particular substantially less (the range in the second mode can be 4 times, in particular 5 times, the range in the first mode), than when using the second mode. This means that, in the second mode, the data from the NFC chip can be read from a substantially greater distance by the NFC antenna.
In the first mode, the energy consumption of the NFC antenna is lower, in particular substantially lower. For example, the energy consumption in the second mode can be approximately 350 times the energy consumption of the NFC antenna in the first mode.

The advantage of changing from the first mode to the second mode is that energy is not consumed unnecessarily by a permanently activated second mode, which is also active when the mobile terminal is not within the capture range and/or the triggering range and/or a predefinable distance from the vehicle and the at least one vehicle door is therefore not intended to be unlocked by means of the digital key. Saving energy makes it possible to save the battery and/or the rechargeable battery of the vehicle. Furthermore, the risk of it no longer being possible to start the vehicle due to an excessively weak battery and/or an excessively weak rechargeable battery is reduced. On the other hand, there is the advantage of a shorter reaction time for unlocking the at least one vehicle door, since the NFC chip and consequently the mobile terminal may be at a greater distance from the NFC antenna and consequently from the vehicle. During an approach movement of the mobile terminal to the at least one NFC antenna, that is to say if the user approaches the vehicle and/or guides the terminal to the NFC antenna by hand, the unlocking process is therefore triggered earlier (at a greater distance of the terminal from the NFC antenna) and accordingly completed earlier, with the result that the user has to wait for a shorter time until he can open the vehicle door. This results in a shorter reaction time of the system to an opening attempt by a user when the user actuates a door handle of the respective vehicle door to open it, because a waiting time for the completion of the possibly still ongoing unlocking process can be shortened. Ideally, the unlocking process has already been completed before the user has come close enough to the vehicle door to be able to reach the door handle, for example. “Close enough” means here in particular closer than a distance value in a range of 1.5 m to 0.5 m. This is usually only achievable in the second mode.

In addition, the change allows a more user-friendly concept. For example, in the first mode, in particular when an LPCD mode is present, the range of the NFC antenna is 1 cm or less. This was tested with various smartphones, in which case the NFC chip was detected by the NFC antenna only at distances between the smartphone and the vehicle door, in which the NFC antenna was located in the example, of 1 cm and less. As a result, the at least one vehicle door was unlocked only at a distance between the smartphone and the vehicle door that falls below the range of the NFC antenna, or, when the smartphone was placed on the vehicle door, sometimes the unlocking did not take place at all, however. This can be prevented by increasing the range of the NFC antenna and thus by changing the NFC antenna from the first mode to the second mode.

The use of NFC technology offers the advantage that, even with an empty rechargeable battery and/or empty battery of the mobile terminal, it is possible to unlock the vehicle, since the NFC chip is read on the vehicle side and thus independently of the state of charge of the mobile device. The disadvantage of an empty rechargeable battery and/or an empty battery of the mobile terminal is that no Bluetooth LE is active, which means that there is no change from the first mode to the second mode.

The invention may include the fact that the first mode is a low power card detection mode (LPCD mode) and/or the second mode is an active polling mode. Both the low power card detection mode and the active polling mode are known from the prior art.

The NFC antenna is preferably located in at least one vehicle door, particularly preferably in the door handle of at least one vehicle door. This can be achieved by virtue of its size of less than 43 mm×13 mm. If the vehicle comprises only one NFC antenna, it is preferably mounted in the door handle of the driver's door. This has the advantage that the driver does not have to go to another door first in order to unlock the vehicle and, after unlocking, immediately stands at the right door in order to open it and get in. Preferably, when the data from the NFC chip are being captured by the NFC antenna (=data capture), all doors are unlocked, so that all doors can be opened and there is no need to unlock other doors separately.

If the vehicle comprises a plurality of NFC antennas, an NFC antenna is preferably located in the door handle of each vehicle door. In the case of data capture, only that door which comprises the NFC antenna used to capture the data can be unlocked. This has the advantage that no unwanted opening of vehicle doors other than that vehicle door which has been unlocked is possible, and thus persons at other doors are still denied access to the vehicle, which can be advantageous in particular in dangerous areas. Alternatively, all doors can be unlocked during data capture, which has the advantage that there is no need to unlock the other doors separately. Preferably, a person, for example, can set which at least one vehicle door is intended to be unlocked. Particularly preferably, the setting can be made depending on the vehicle door in which the NFC antenna used to capture the data is located.

Additionally or alternatively, the tailgate may comprise an NFC antenna. When data are being captured by the NFC antennas in the tailgate, only the tailgate can be unlocked or all vehicle doors including the tailgate are unlocked. Preferably, the tailgate is automatically opened when data are being captured by the NFC antenna in the tailgate. This has the advantage of user-friendly loading of the vehicle.

Additionally or alternatively, the hood may comprise an NFC antenna. When data are being captured by the NFC antenna in the hood, the hood can be unlocked, preferably automatically opened. This has the advantage that, in order to unlock the hood, the driver's door does not have to be unlocked and opened first in order to unlock the hood from the interior of the vehicle. This is therefore a particularly user-friendly concept.

The invention also includes developments that result in additional advantages.

One development comprises that at least one distance measurement between the vehicle and the mobile terminal is carried out by means of at least one measurement of an RSSI value of the Bluetooth LE signal from the terminal Bluetooth module, and the at least one NFC antenna changes from the first mode to the second mode only when the distance measurement results in a value that is less than a predefinable RSSI distance value.

In other words, when the terminal Bluetooth module enters the capture range of the vehicle Bluetooth module, a distance measurement is carried out, i.e. the distance between the terminal Bluetooth module and the vehicle Bluetooth module is measured. Preferably, the distance measurement is carried out several times, in particular at predefinable time intervals, wherein the distance measurement is preferably completed only when at least one vehicle door was unlocked and/or the terminal Bluetooth module leaves the capture range of the vehicle Bluetooth module. Preferably, the time interval is a period of at most two seconds, preferably at most one second.

The distance measurement is carried out by measuring the RSSI value. RSSI is the abbreviation known from the prior art for Received Signal Strength Indicator, in which case the measurement of the RSSI value can be based on a method known from the prior art. The RSSI value describes the signal strength of the Bluetooth LE signal received by a receiving device. Since this value of the signal strength is distance-dependent, the distance between the two devices can be inferred from the signal strength.

Only when a value that falls below the predefinable RSSI distance value is determined during the distance measurement does the change from the first mode to the second mode take place, even if the terminal Bluetooth module already previously entered the capture range of the vehicle Bluetooth module. In other words, the triggering range within which a change from the first mode to the second mode takes place is that range which can be assigned at least to both the capture range and to that range within which the distance measurement results in a value less than the RSSI distance value. The RSSI distance value describes a predefinable distance value here. The RSSI distance value can be predefined and, for example, can have a value of at most 10 m, preferably at most 5 m, particularly preferably at most 3 m. Additionally or alternatively, the RSSI distance value can also be predefined by a person. Preferably, the RSSI distance value can be set on the mobile terminal and/or can be selected from a predefinable set of distances.

One development comprises that at least one distance measurement between the vehicle and the mobile terminal is carried out by means of channel sounding, and the at least one NFC antenna changes from the first mode to the second mode only when the distance measurement results in a value that is less than a predefinable CS distance value.

In other words, when the terminal Bluetooth module enters the capture range of the vehicle Bluetooth module, a distance measurement is carried out, i.e. the distance between the terminal Bluetooth module and the vehicle Bluetooth module is measured. Preferably, the distance measurement is carried out several times, in particular at predefinable time intervals, wherein the distance measurement is preferably completed only when at least one vehicle door was unlocked and/or the terminal Bluetooth module leaves the capture range of the vehicle Bluetooth module. Preferably, the time interval is a period of at most two seconds, preferably at most one second.

The distance measurement is carried out using channel sounding, as is known from the prior art. The principle behind this is to measure a phase difference between an outgoing and an incoming wave at multiple frequencies. This means that, for one frequency in each case, a first device emits a Bluetooth LE signal that is received by a second device. The second device then in turn emits a Bluetooth LE signal that is received by the first device. This is carried out for multiple frequencies. Since the Bluetooth LE signals are waves, the phase difference between the Bluetooth LE signal emitted by the first device and the Bluetooth LE signal received by the first device can be determined. A distance measurement can be carried out based on the knowledge of the phase differences at different frequencies.

Only when a value that falls below the predefinable CS distance value is determined during the distance measurement does the change from the first mode to the second mode take place, even if the terminal Bluetooth module already previously entered the capture range of the vehicle Bluetooth module. In other words, the triggering range within which a change from the first mode to the second mode takes place is that range which can be assigned at least to both the capture range and to that range within which the distance measurement results in a value less than the CS distance value. The CS distance value describes a predefinable distance value here. The CS distance value can be predefined and, for example, can have a value of at most 10 m, preferably at most 5 m, particularly preferably at most 3 m. Additionally or alternatively, the CS distance value can also be predefined by a person. Preferably, the CS distance value can be set on the mobile terminal and/or can be selected from a predefinable set of distances.

The distance measurement, irrespective of whether it is carried out by measuring the RSSI value or channel sounding, and the subsequent change from the first mode to the second mode depending on the value of the distance measurement, offers the advantage of being able to further reduce the energy consumption. This is the case in particular when the RSSI distance value and/or the CS distance value is/are less than the distance between the terminal Bluetooth module and the vehicle Bluetooth module when the terminal Bluetooth module enters the capture range, since in this case the triggering range is smaller than the capture range. This has the advantage that the change from the first mode to the second mode takes place at a later time than when the change takes place when the terminal Bluetooth module enters the capture range. As a result, the second mode, which is distinguished by a substantially higher energy consumption, is activated only later and is preferably active for a shorter time, which consumes less energy overall.

It is particularly preferred to carry out at least one distance measurement by measuring the RSSI value and to carry out at least one distance measurement via channel sounding. This results in the advantage that two measurement methods for determining the distance are performed, thus making it possible to measure the distance in a more accurate and more undisturbed manner. Preferably, the CS distance value and the RSSI distance value have the same value.

One development comprises that use of UWB technology is dispensed with in order to trigger the unlocking of the at least one vehicle door and/or to carry out at least one distance measurement. In other words, the mobile terminal for unlocking the at least one vehicle door and/or for the distance measurement need not include a UWB chip. This results in the advantage that substantially more mobile terminals, in particular also mobile terminals from Chinese manufacturers, are configured to carry out the method in combination with a vehicle according to the invention.

One development comprises that the at least one NFC antenna changes from the second mode back to the first mode if at least one of the following points is given:
a. A predefinable time period is reached since the change from the first mode to the second mode. The time period can either be predefined or set by a person, preferably on the mobile terminal. The time period can be, for example, a time period between 3 min and 20 min, preferably between 5 min and 10 min. This has the advantage that the second mode is not active for an unnecessarily long time, as it can happen, for example, if a person carrying the mobile terminal is present for a longer time (in particular longer than the predefinable time period) in the triggering range (triggering range=sharp range=capture range and/or in the range characterized by the CS distance value and/or RSSI distance value), but without tracking the unlocking of at least one vehicle door.
b. A predefinable exceeding distance between the vehicle and the mobile terminal, in particular between the vehicle Bluetooth module and the terminal Bluetooth module, is exceeded. For example, the exceeding distance can have values between 3 m and 10 m, preferably between 5 m and 8 m. In particular, the exceeding distance may be the RSSI distance value and/or the CS distance value. The distance can be determined, for example, by measuring the RSSI value and/or via channel sounding. The change for the given reason can be useful in particular when a person carrying the mobile terminal enters the triggering range, for example because the person passes the vehicle, but does not intend to trigger unlocking of at least one vehicle door. This has the advantage of avoiding an unnecessarily high energy consumption caused by the NFC antenna remaining in the second mode for an unnecessarily long time.
c. At least one battery and/or at least one rechargeable battery of the vehicle fall(s) below at least a predefinable amount of electrical energy. The predefinable amount of electrical energy can be an absolute specification and/or a relative specification. The advantage is that, if there is an excessively small amount of electrical energy in the battery and/or in the rechargeable battery of the vehicle, the second mode, which consumes significantly more energy than the first mode, is switched off. This means that it is still possible to unlock the vehicle via the first mode—even though a substantially shorter distance between the mobile terminal and the NFC antenna is required, the load on the battery and/or the rechargeable battery of the vehicle is also reduced. This can reduce the risk of the vehicle no longer being able to be started due to excessively small amounts of energy in the battery and/or in the rechargeable battery of the vehicle.
d. The terminal Bluetooth module is no longer detected by the vehicle Bluetooth module. This means that the terminal Bluetooth module has left the capture range. This can prevent an unnecessary energy consumption due to the second mode.
e. The at least one vehicle door has been unlocked. In this case, it can be assumed that no further unlocking by means of the digital key is intended to be carried out, which means that, if the NFC antenna remains in the second mode, it would be an unnecessary energy consumption.

In particular, provision may be made for a change from the second mode back to the first mode to only take place if at least one of the conditions mentioned under a-e occurs.

One development comprises that a change back from the first mode to the second mode takes place if the detection of the terminal Bluetooth module by the vehicle Bluetooth module has not been interrupted and a reduction in a distance between the terminal Bluetooth module and the vehicle Bluetooth module is detected. The detection of the terminal Bluetooth module by the vehicle Bluetooth module begins in particular when the terminal Bluetooth module enters the capture range and preferably ends when the terminal Bluetooth module leaves. If the detection is not interrupted, that is to say the terminal Bluetooth module does not leave the capture range, and the NFC antenna has changed from a second mode to the first mode, and there is a reduction in the distance between the terminal Bluetooth module and the vehicle Bluetooth module, a change from the first mode to the second mode takes place. This may be due, for example, to a longer dwell time in the tripping range or to a departure from the tripping range, which causes a change from the second mode to the first mode for energy-related reasons. If the plan to unlock the at least one vehicle door is then continued, a change back to the second mode makes sense, since this preserves the user-friendly operating concept and/or the greater possible distance between the NFC antenna and the NFC chip, while at the same time reducing the energy consumption as much as possible.

One development comprises that, for a change of the at least one NFC antenna from the first mode to the second mode,
the vehicle Bluetooth module must have been coupled at least once to the terminal Bluetooth module and/or
the terminal Bluetooth module is in the list of known Bluetooth modules of the vehicle Bluetooth module.

In other words, the vehicle Bluetooth module and the terminal Bluetooth module have already been paired, as is known from the prior art, so that a change from the first mode to the second mode takes place.

This has the advantage that only selected mobile terminals, namely those which have already been paired with the vehicle, can initiate a change from the first mode to the second mode. This prevents a change from the first mode to the second mode being able to take place when a mobile terminal, which does not belong to the selected mobile terminals, enters the triggering range. This prevents an unnecessary change from the first mode to the second mode, for example due to a mobile terminal, which makes it possible to unlock the at least one vehicle door, entering the triggering range, because the NFC chip, for example, is not stored in the memory of the vehicle. This prevents an unnecessarily high energy consumption.

One development comprises that, after unlocking the vehicle, predefinable commands relating to the vehicle are transmitted from the mobile terminal to the vehicle via a connection between the vehicle Bluetooth module and the terminal Bluetooth module. In other words, the vehicle executes predefinable commands after the unlocking. The commands are preferably input by a person via the mobile terminal. If there are multiple digital keys, that is to say the vehicle can be unlocked via multiple mobile terminals, provision is preferably made for the predefinable commands to be able to be individually set; that is to say, when unlocking the vehicle with a first mobile terminal, first commands are executed by the vehicle and, when unlocking the vehicle by means of a second mobile terminal, second commands, which may at least partially differ from the first commands, are executed by the vehicle.

The commands may include, for example: an adjustment of at least one seat in the vehicle, the activation of the air conditioning system and/or the heater, preferably with the setting of a predefinable temperature, the lowering of at least one window of the vehicle, the adjustment of settings of the vehicle to settings previously assigned to an account, the adjustment of the settings of at least one driver assistance system to predefinable values, the adjustment of at least one mirror, in particular an exterior mirror, of the vehicle, the opening of at least one predefinable vehicle door and/or the trunk, the restriction of the driving properties of the vehicle, for example the engine power, the maximum torque that can be applied by the engine and/or the maximum speed, and/or the adjustment of the entertainment system to a predefinable setting.

This has the advantage of personalizing the vehicle, in particular personalizing the vehicle to different users who have access to the vehicle at different times. This improves the user experience. Additionally or alternatively, it is possible to restrict predefinable users when using the vehicle. Different users are distinguished by the use of different mobile terminals for unlocking at least one vehicle door.

In addition, the invention comprises a system comprising at least one vehicle and at least one mobile terminal, which are configured to carry out the method according to the invention. In particular, the invention comprises the fact that the method can be carried out on one or more vehicles by means of a mobile terminal. Additionally or alternatively, the invention comprises the fact that the method can be carried out on a vehicle by means of multiple mobile terminals, that is to say that a vehicle can be unlocked by means of multiple mobile terminals on the basis of the method according to the invention.

In addition, the invention comprises a vehicle comprising at least one NFC antenna for receiving NFC signals and a vehicle Bluetooth module, wherein the vehicle is configured to carry out the method according to the invention.

Further features of the invention emerge from the claims, the figures and the description of the figures. The features and combinations of features mentioned above in the description, and the features and combinations of features mentioned below in the description of the figures and/or shown in the figures alone, may be used not only in the respectively specified combination but also in other combinations or alone.

The invention will now be explained in more detail on the basis of a preferred exemplary embodiment and with reference to the drawings, in which:

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 shows a schematic perspective view.

### DETAILED DESCRIPTION OF THE DRAWING

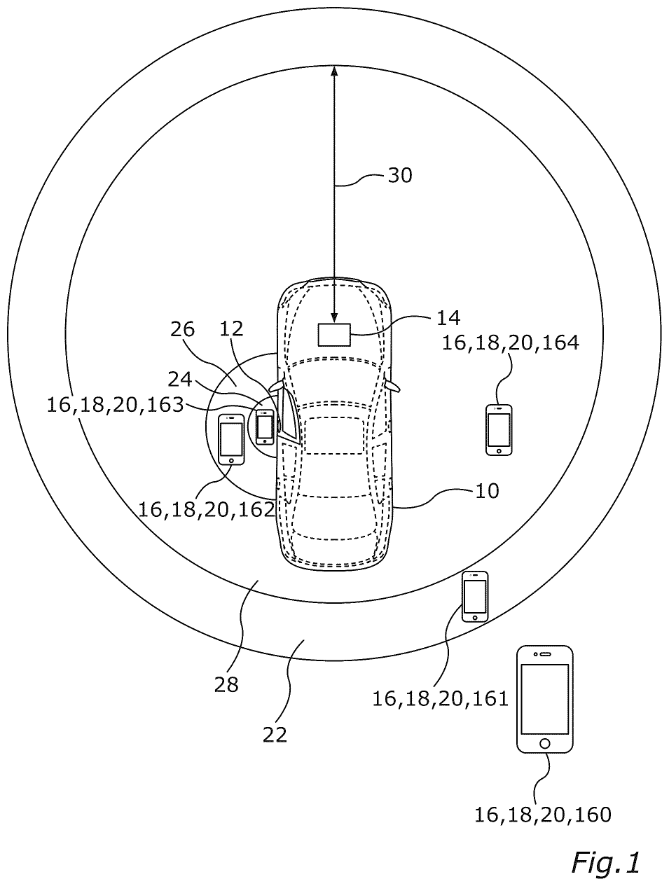

FIG. 1 shows a vehicle 10 comprising at least one NFC antenna 12 which is located in the given example in the handle of that vehicle door which is located at the front on the driver's side. The NFC antenna 12 can also be located at any other location in the vehicle 10. Furthermore, the case of one NFC antenna is described here; the case of a vehicle 10 having more than one NFC antenna 12 is not intended to be excluded thereby and follows accordingly from the case with one NFC antenna 12. In addition to the NFC antenna 12, the vehicle 10 comprises a vehicle Bluetooth module 14.

In addition to the vehicle 10, FIG. 1 shows a mobile terminal 16 which comprises an NFC chip 18 and a terminal Bluetooth module 20. If the mobile terminal 16, 160 is outside the capture range 22, no communication and in particular no connection can be carried out between the vehicle Bluetooth module 14 and the terminal Bluetooth module 20. The capture range 22 is defined by the range of the Bluetooth LE signal emitted by the vehicle Bluetooth module 14. In particular, the capture range 22 is defined as the largest possible range in which a connection and/or communication can be set up between the vehicle Bluetooth module 14 and the terminal Bluetooth module 20.

If the mobile terminal 16, 161, 162, 163, 164 enters the capture range 22 and the entry is detected, for example by establishing a connection, in particular a communication connection, between the vehicle Bluetooth module 14 and the terminal Bluetooth module 20, this is signaled to the NFC antenna 12. If the triggering range corresponds to the capture range 22, a change from the first mode to the second mode takes place. The first mode can be the LPCD mode. The second mode can be the active polling mode.

Since the second mode consumes more energy, in particular substantially more energy (for example up to 350 times more energy), than the first mode, the intention is to prevent an unnecessary change from the first mode to the second mode. A distance measurement may be provided for this purpose, thus determining a Bluetooth range 28 which is at least partially within the capture range 22. In this case, that range which the capture range 22 and the Bluetooth range 28 have in common can be considered to be the triggering range. In particular, the Bluetooth range 28 can be equal to the triggering range. If the Bluetooth range 28 is defined, provision can be made for only mobile terminals 16, 162, 163, 164 which are within the Bluetooth range 28 to be able to initiate a change from the first mode to the second mode. This means that mobile terminals 16, 161 within the capture range 22 but outside the Bluetooth range 28 do not initiate a change from the first mode to the second mode.

The Bluetooth range 28 is preferably defined using a predefinable distance value 30 which is referred to either as an RSSI distance value 30 or as a CS distance value 30, depending on the distance measurement method. A distance measurement can be carried out in order to determine whether the mobile terminal 16, 161, 162, 163, 164 is within the Bluetooth range 28. The distance measurement can be carried out by measuring the RSSI value or by means of channel sounding. Preferably, both methods (measurement of the RSSI value and channel sounding) for determining the distance are used to determine the distance between the mobile terminals 16, 161, 162, 163, 164 as accurately as possible. The distance value 30 can be set via the mobile terminal 16.

The change from the first mode to the second mode increases the range in which the NFC chip can be detected and the data from the NFC chip 18 can be read by the NFC antenna 12. That range in which the data from the NFC chip 18 can be read by the NFC antenna 12 in the first mode is given by the inner NFC range 24. That range in which the data from the NFC chip 18 can be read by the NFC antenna in the second mode is given by the outer NFC range 26. If the data from the NFC chip 18 are captured by the NFC antenna 12 and the NFC chip 18 is preferably an NFC chip 18 known to the vehicle 10, at least one vehicle door of the vehicle 10 is unlocked. Overall, this means that, in the case of an NFC antenna 12 in the first mode, only the mobile terminal 16, 163 in the inner NFC range 24 can unlock the at least one vehicle door, whereas, in the case of an NFC antenna 12 in the second mode, the mobile terminal 16, 162 in the outer NFC range 26 and the mobile terminal 16, 163 in the inner NFC range can unlock the at least one vehicle door.

The change from the first mode to the second mode thus offers the advantage that the at least one vehicle door of the vehicle 10 can be unlocked from a greater distance, that is to say the distance between the NFC chip 18, and thus the mobile terminal 16, and the NFC antenna 12, and thus the vehicle 10, may be greater when using the second mode than when using the first mode, thereby reducing the reaction time for unlocking the at least one vehicle door.

Preferably, the change from the first mode to the second mode takes place only if the vehicle Bluetooth module 14 and the terminal Bluetooth module 20 have already been paired, that is to say a connection, in particular a communication connection, preferably an exchange of data, has taken place between the vehicle Bluetooth module 14 and the terminal Bluetooth module 20.

The method can be based on the fact that no UWB technology is used, that is to say the method can also be carried out by means of mobile terminals 16 which do not comprise a UWB chip.

If a change from the first mode to the second mode took place, provision may be made for a change back from the second mode to the first mode to take place if at least one predefinable condition is present. Predefinable conditions are given, for example, in the description, which in particular should not be understood as meaning that other predefinable conditions cannot result in a change from the second mode back to the first mode. A predefinable condition preferably has the property that, when the predefinable condition is met, it can be assumed that the person carrying the mobile terminal 16 does not have the aim of unlocking the vehicle 10, for example because the person simply passes the vehicle 10, and/or the original aim of unlocking at least one vehicle door of the vehicle 10, for which reason the mobile terminal 16 in particular approached the vehicle 10, has turned into a new aim, and so only the new aim is pursued.

It may be the case that, despite the occurrence of at least one predefinable condition which resulted in a change from the second mode to the first mode, unlocking of the at least one vehicle door of the vehicle 10 is provided. This may be the case, for example, if something needed to be done in the vicinity of the vehicle 10, in particular in the capture range 22 and/or in the Bluetooth range 28 and/or in the triggering range, for example a repair on the vehicle 10 and/or contact with another person. It may then be useful to initiate a change from the first mode back to the second mode. If a change from the second mode to the first mode took place, but a change back is provided, the change back can take place in particular when it is detected that the terminal Bluetooth module 20 is approaching the vehicle Bluetooth module 14.

If the vehicle 10 has been unlocked, provision may be made for predefinable commands to be transmitted from the mobile terminal 16 to the vehicle 10, in particular via the connection (communication connection) between the terminal Bluetooth module 20 and the vehicle Bluetooth module 14. In particular, the predefinable commands may include the adjustment of settings of the vehicle 10 to settings previously assigned to an account. This means that at least one account has been created in the vehicle 10, in which values are stored for various settings that have been set. For example, it is possible to set a seat position and/or values and/or settings for at least one driver assistance system. This means that modifiable parameters (=settings) have been assigned values that are stored in the account. If the vehicle 10 is unlocked, provision may be made for those settings which have been assigned values in the account to be set according to the assigned values. In this case, at least one NFC chip 18 is linked to an account, and so the settings of that account which is linked to that NFC chip 18 which was used to unlock the vehicle 10 are adopted.

A particularly preferred exemplary embodiment shall be presented below. The aim here is to improve the detection of at least one NFC chip in at least one mobile terminal by means of at least one NFC antenna in a vehicle. It is taken into account that the detection of the NFC chip by means of the NFC antenna is worse when the NFC antenna is in the first mode (LPCD mode) than when it is in the second mode (active polling). The idea is that the distance between the mobile terminal and the vehicle is determined by means of Bluetooth. A change from the first mode to the second mode takes place on the basis of the distance, in which case a change back from the second mode to the first mode preferably takes place after a predefinable time. The distance determination can be used to predict expected access to the vehicle, provided that the mobile terminal was already connected to the vehicle via Bluetooth. This can provide a better user experience.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Signs

10 Vehicle
12 NFC antenna
14 Vehicle Bluetooth module
16 Mobile terminal
160 Mobile terminal outside the capture range
161 Mobile terminal in the capture range
162 Mobile terminal in the outer NFC range
163 Mobile terminal in the inner NFC range
164 Mobile terminal in the Bluetooth range
18 NFC chip
20 Terminal Bluetooth module
22 Capture range
24 Inner NFC range
26 Outer NFC range
28 Bluetooth range
30 Distance value

What is claimed is:

1. A method for unlocking at least one vehicle door of a vehicle via a mobile terminal, wherein
a. the vehicle comprises at least one NFC antenna for receiving NFC signals and a vehicle Bluetooth module for communication via Bluetooth LE, and
b. the mobile terminal comprises a terminal Bluetooth module for communication via Bluetooth LE and an NFC chip,
c. wherein the at least one NFC antenna is configured to capture data from the NFC chip and then trigger the unlocking,
wherein the method comprises:
upon detection of entry of the terminal Bluetooth module into a predetermined triggering range of the vehicle Bluetooth module, which is determined at least by a capture range limited by the range of a Bluetooth LE signal, signaling the entry to the at least one NFC antenna, and
then changing the at least one NFC antenna from a first mode to a second mode, the first mode being distinguished by a shorter range for capturing the data from the NFC chip than the second mode, and the changing from the first mode to the second mode results in a shorter waiting time for the unlocking of the at least one vehicle door for a user approaching with the mobile terminal and/or provides a shorter reaction time for the unlocking during an approach movement of the mobile terminal to the at least one NFC antenna.

2. The method according to claim 1, wherein
at least one distance measurement between the vehicle and the mobile terminal is carried out via at least one measurement of an RSSI value of the Bluetooth LE signal from the terminal Bluetooth module, and
the at least one NFC antenna changes from the first mode to the second mode only when the distance measurement results in a value that is less than a predefinable RSSI distance value.

3. The method according to claim 1, wherein
at least one distance measurement between the vehicle and the mobile terminal is carried out via channel sounding, and
the at least one NFC antenna changes from the first mode to the second mode only when the distance measurement results in a value that is less than a predefinable CS distance value.

4. The method according to claim 1, wherein
use of UWB technology is dispensed with in order to trigger the unlocking of the at least one vehicle door and/or to carry out at least one distance measurement.

5. The method according to claim 1, wherein
the at least one NFC antenna changes from the second mode back to the first mode when at least one of:
a. a predefinable time period is reached since the change from the first mode to the second mode,
b. a predefinable exceeding distance between the vehicle and the mobile terminal is exceeded,
c. at least one battery and/or at least one rechargeable battery of the vehicle fall(s) below at least a predefinable amount of electrical energy,
d. the terminal Bluetooth module is no longer detected by the vehicle Bluetooth module,
e. the unlocking of the at least one vehicle door is detected.

6. The method according to claim 5, wherein
a change back from the first mode to the second mode takes place when the detection of the terminal Bluetooth module by the vehicle Bluetooth module has not been interrupted and a reduction in a distance between the terminal Bluetooth module and the vehicle Bluetooth module is detected.

7. The method according to claim 1, wherein
for a change of the at least one NFC antenna from the first mode to the second mode,
a. the vehicle Bluetooth module must have been coupled at least once to the terminal Bluetooth module, and/or
b. the terminal Bluetooth module is in a list of known Bluetooth modules of the vehicle Bluetooth module.

8. The method according to claim 1, wherein
after the vehicle has been unlocked, predefinable commands relating to the vehicle are transmittable from the mobile terminal to the vehicle via a connection between the vehicle Bluetooth module and the terminal Bluetooth module.

9. A system, comprising:
at least one vehicle; and
at least one mobile terminal, which vehicle and mobile terminal are configured to:
a. the vehicle comprises at least one NFC antenna for receiving NFC signals and a vehicle Bluetooth module for communication via Bluetooth LE, and
b. the mobile terminal comprises a terminal Bluetooth module for communication via Bluetooth LE and an NFC chip,
c. wherein the at least one NFC antenna is configured to capture data from the NFC chip and then trigger the unlocking,
wherein the method comprises:
upon detection of entry of the terminal Bluetooth module into a predetermined triggering range of the vehicle Bluetooth module, which is determined at least by a capture range limited by the range of a Bluetooth LE signal, signaling the entry to the at least one NFC antenna, and
then changing the at least one NFC antenna from a first mode to a second mode, the first mode being distinguished by a shorter range for capturing the data from the NFC chip than the second mode, and the changing from the first mode to the second mode results in a shorter waiting time for the unlocking of the at least one vehicle door for a user approaching with the mobile terminal and/or provides a shorter reaction time for the unlocking during an approach movement of the mobile terminal to the at least one NFC antenna.

10. A vehicle, comprising:
at least one NFC antenna for receiving NFC signals; and
a. a vehicle Bluetooth module, which is configured to the vehicle comprises at least one NFC antenna for receiving NFC signals and a vehicle Bluetooth module for communication via Bluetooth LE, and
b. the mobile terminal comprises a terminal Bluetooth module for communication via Bluetooth LE and an NFC chip,
c. wherein the at least one NFC antenna is configured to capture data from the NFC chip and then trigger the unlocking,
wherein the method comprises:
upon detection of entry of the terminal Bluetooth module into a predetermined triggering range of the vehicle Bluetooth module, which is determined at least by a capture range limited by the range of a Bluetooth LE signal, signaling the entry to the at least one NFC antenna, and
then changing the at least one NFC antenna from a first mode to a second mode, the first mode being distinguished by a shorter range for capturing the data from the NFC chip than the second mode, and the changing from the first mode to the second mode results in a shorter waiting time for the unlocking of the at least one vehicle door for a user approaching with the mobile terminal and/or provides a shorter reaction time for the unlocking during an approach movement of the mobile terminal to the at least one NFC antenna.
